(19) United States
(12) Patent Application Publication
(10) Pub. No.: US 2017/0069109 A1
(43) Pub. Date: Mar. 9, 2017

(54) METHOD AND APPARATUS FOR MEASURING AN OBJECT

(71) Applicant: MOTOROLA SOLUTIONS, INC., Chicago, IL (US)

(72) Inventors: VADIM PEPELKA, ST. PETERSBURG (RU); WEI LIN, LAKE ZURICH, IL (US); EVGENY MARYASKIN, ST. PETERSBURG (RU); ILYA BORISOVICH POZDNOV, ST. PETERSBURG (RU)

(21) Appl. No.: 15/125,587

(22) PCT Filed: May 29, 2014
(86) PCT No.: PCT/RU2014/000399

§ 371 Date: Sep. 13, 2016

(51) Int. Cl. G06T 7/60; G06K 9/00; G06T 7/00; G01B 11/02

(52) U.S. Cl. CPC G06T 7/60; G01B 11/022; G06K 9/0061; G06T 7/0042; G06T 2207/10004; G06T 2207/30201

(57) ABSTRACT

A method and apparatus for measuring a distant object by using both a front camera and back camera of, for example, a cellular telephone. The cameras may or may not be used simultaneously. The back camera is directed towards the object being measured, the front camera is directed to the operator of the device. The measurement of the object is accomplished using two or more pictures of the object taken from different positions. A distance between these positions that is calculated from the pictures of one or several reference objects\points taken by the frontal camera.

### FIELD OF THE INVENTION

The present invention generally relates to measuring an object, and more particularly to a method and apparatus for measuring a height, width, length, or other dimension of a distant object.

### BACKGROUND OF THE INVENTION

Measuring the length, height, or width of an object is usually performed using an instrument or device marked in standard units or by comparing the object with a second object of known size. For example, a person wishing to measure a height of a person may use a yardstick or ruler. Using a yardstick or ruler may not be the best approach for measuring distant or tall objects. For example, measuring a height of a building would be very difficult to do using a ruler. With this in mind, it would be beneficial if a user can obtain a measurement of an object without having to use a ruler to do so.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a general operational environment of the present invention.

FIG. 2 is a block diagram of the device of FIG. 1.

FIG. 3 illustrates the calculation of an object height.

FIG. 4 is a flow chart showing operation of the device of FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above, mentioned need, a method and apparatus for measuring an object is provided herein. During operation a camera is used at a first position to take a first picture a target object. The camera is moved to a second position and used to take a second picture of the target object. A distance (D) between camera positions is determined. Once D is determined, a first pixel height (H₁) of the target object on a CCD is determined from a picture taken at the first position and a second pixel height (H₂) of the target object on the CCD is determined from a picture taken at the second position. H₁, H₂, and D are then used to determine the actual height of the target object. The actual height of the target object is then presented to the user in units of measure such as meters or feet.

The above-described technique provides for technique to measure a distant object by using both a front camera and a back camera of, for example, a cellular telephone. The cameras may or may not be used simultaneously. The back camera is directed towards the object being measured, the front camera is directed to the operator of the device. The measurement of the object is accomplished using two or more pictures of the object taken from different positions. A distance between these positions that is calculated from the pictures of one or several reference objects\points taken by the frontal camera.

The above approach requires knowing the distance D between the first and the second camera positions. In an embodiment of the present invention, biometric markers (such as features of a human face or head) are used for the calculation of camera displacement (D). Such a feature may comprise a distance between human eyes, size of pupils, size of mouth, size of nose, . . . , etc. For simplicity of describing the present invention, a distance between the eyes of an individual will be used when describing operation, however one of ordinary skill in the art will recognize that any biometric marker may be used in a similar manner.

The below description and figures will be used to detail operation in accordance with several embodiments of the present invention. It should be noted, that for ease of explanation, a distant object's height will be determined and described below. One of ordinary skill in the art will recognize that any measurement besides height (e.g., length, width, . . . , etc.) may be determined in a similar manner.

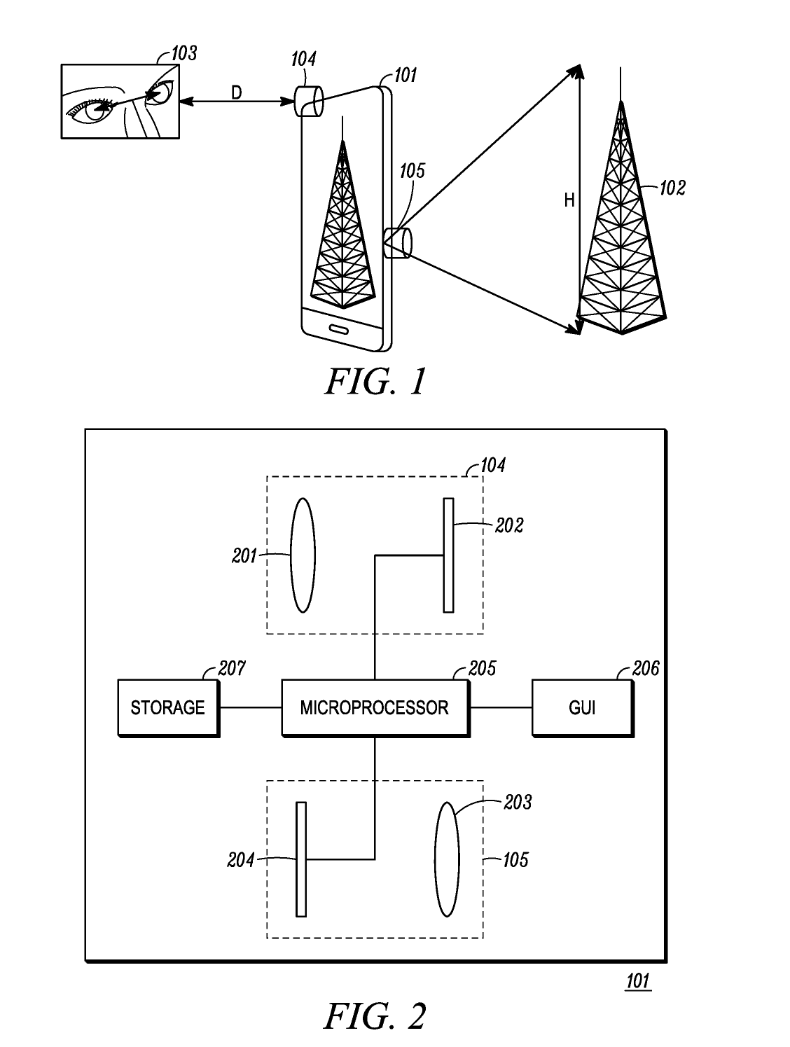

FIG. 1 illustrates a general operational environment of the present invention. As shown, device 101 comprises first camera 104 that is used to take a first picture of a user 103 at a distance D₁ from the user. Device 101 also comprises second camera 105 used to take a first picture of object 102. First camera 104 and second camera 105 take both pictures substantially simultaneously.

Device 101 is then moved to a second position, a distance D₂ from the user. First camera 104 is used to take a second picture of the user 103 at the distance D₂ from the user. Second camera 105 simultaneously takes a second picture of object 102. D₁ and D₂ are calculated as:

$${D}_{i} = \frac{L \cdot {F}_{pix}}{{N}_{i}} = \frac{L \cdot {F}_{eff} \cdot R}{{N}_{i} \cdot S} \qquad ( 1 )$$

where

L—is the size of the reference object (in meters), in this case, a distance between a user's eyes;

Fpix—focal length of camera 104 (in pixels);

R—is the size of the reference object (in pixels), in this case, a distance between a user's eyes;

F_{eff}—effective focal length of camera 104 in mm;

S—CCD size within camera 104 in mm; and

Ni—pixel size on CCD of the reference object for i-th position.

A distance (D) between camera positions D₁ and D₂ is determined as the absolute value of D₂−D₁. More particularly,

D=D2−D1 (2)

Once D is determined, a first pixel height (H₁) of the target object 102 is determined from the object's picture taken by the second camera at the first position and a second pixel height (H₂) of the target object 102 is determined from the object's picture taken by the second camera at the second position. H₁, H₂, and D are then used to determine the actual height of the target object. More specifically,

$$H = \frac{{H}_{1} \cdot {H}_{2} \cdot D}{\vert {H}_{1} - {H}_{2} \vert \cdot {F}_{pix}} \qquad ( 3 )$$

where,

H₁ and H₂ are pixel heights of the target object on a CCD of camera 105 at position D₁ and position D₂, respectively; and

Fpix is the focal length of camera 105 in pixels.

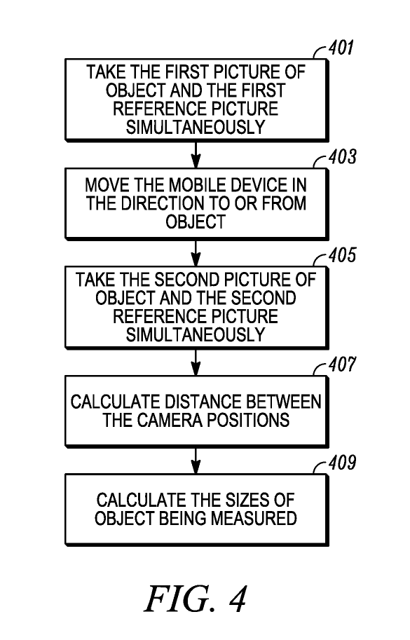

FIG. 2 is a block diagram of device 101 of FIG. 1. As shown, device 101 comprises a first camera 104 having first lens 201 and first charged-coupled device (CCD) 202. Second camera 105 is provided having second lens 203 and second CCD 204. Microprocessor 205 is provided as logic circuitry 205 that controls device 101 and performs functions, some of which are shown in FIG. 4. Logic circuitry 205 comprises a digital signal processor (DSP), general purpose microprocessor, a programmable logic device, or application specific integrated circuit (ASIC) and is utilized to determine a height of object 102. Storage 207 comprises standard random access memory and is used to store information used to calculate a height of a distant object (such as images).

GUI 206 serves to provide information to a user and to receive information from a user. For example, GUI 206 may receive an input from a user to initiate a measurement of a distant object. In addition, in an embodiment, GUI 206 provides a way of conveying (e.g., displaying) information to the user. In particular, during the measurement of an object, logic circuitry 205 may use GUI 206 to instruct the user to move device 101 to another location (D₂), may use GUI 206 to instruct the user to acquire images used in calculating the measurement of the object, and may use GUI 206 to provide the calculated height of the distant object to the user.

In order to provide the above features (and additional features), GUI 206 preferably comprises a touch screen similar to those used in many smart phones. In alternate embodiments GUI 206 may include a monitor, a keyboard, a mouse, and/or various other hardware components to provide a man/machine interface. CCD 202 and CCD 204 are sensors used to record still and/or moving images.

CCDs 202 and 204 captures light and converts it to digital data that is recorded by microprocessor 205 and stored in storage 207 that is coupled to microprocessor 205. For this reason, a CCD is often considered the digital version of film. The quality of an image captured by a CCD depends on the resolution of the sensor. In digital cameras, the resolution is measured in Megapixels (or thousands of pixels). As shown in FIG. 1 and FIG. 2, the first and the second cameras 104 and 105 are preferably pointing in the opposite direction.

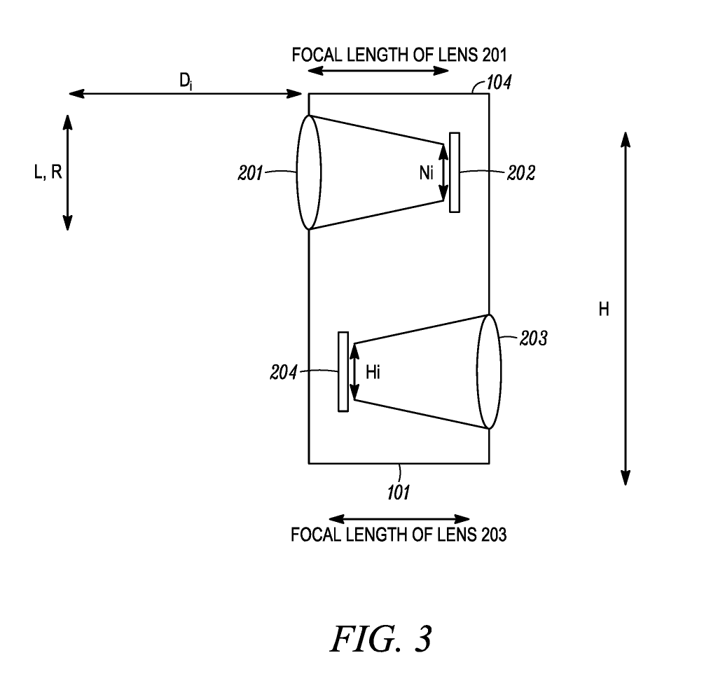

FIG. 3 illustrates the calculation of an object height. As shown in FIG. 3, at a time Ti, device 101 is a distance Di from user 103. At this distance, the user's image is cast upon CCD 202. A biometric marker (in this case the distance between the user's eyes) is projected upon CCD 202 and is Ni pixels in length upon CCD 202. In actuality, the biometric marker is L meters in length, and R pixels in length. Pixel distance between biometric features is estimated based on detection of these features in recorded images. Simultaneously, an image of object 102 is cast upon CCD 204, and is Hi pixels in length as cast upon CCD 204. Each lens 201 and 203 has a focal length that can be differing from each other, and can be measured in pixels or millimeters.

FIG. 4 is a flow chart showing operation of the device of FIG. 2. The logic flow begins at step 401 where first camera 104 takes a first picture of a biometric marker and second camera 105 takes a first picture of object 102. As discussed above, both pictures are taken substantially at the same time at a distance D₁ from the user. Logic circuitry 205 may store these pictures for later analysis. At step 403 the camera is moved by the user to a second position, a second distance D₂ from the user. First camera 104 then takes a second picture of the biometric marker and second camera 105 then takes a second picture of object 102. Logic circuitry may store these images for later analysis. It should be noted that logic circuitry 205 may use GUI 206 instruct the user to move device 101 accordingly and to acquire the various pictures.

At step 407 a distance D is calculated as described above by logic circuitry 205. As discussed above, D comprises an absolute value of D₂−D₁. Finally, at step 409, logic circuitry calculates the height of object 102. The height of object 102 may be presented to a user via GUI 206.

The above technique provides for an apparatus comprising a first camera acquiring a first image of the object and acquiring a second image of the object, a second camera acquiring a first image of a biometric marker at a first distance (D₁) and acquiring a second image of the biometric marker at a second distance (D₂), and logic circuitry measuring a size (N₁) the biometric marker at the first distance, measuring a size (N₂) of the biometric marker at the second distance, and calculating the size of the object (H) based on the size measurements of the biometric marker at the first and the second distances.

As described above, the biometric marker comprises, for example, a distance between the eyes or a size of a pupil, and N₁ and N₂ are measured in pixel lengths. The logic circuitry determines a distance D as an absolute value of D₂−D₁; and

$$H = \frac{{H}_{1} \cdot {H}_{2} \cdot D}{\vert {H}_{1} - {H}_{2} \vert \cdot {F}_{pix}}$$

where,

Fₚᵢₓ is the focal length of the first camera in pixels.

The logic circuitry calculates D₁ and D₂ as

$${D}_{i} = \frac{L \cdot {F}_{pix}}{{N}_{i}} = \frac{L \cdot {F}_{eff} \cdot R}{{N}_{i} \cdot S}$$

where

L—is a size of the biometric marker in meters;

Fpix—focal length of the first camera in pixels;

R—is the size of the biometric marker in meters;

F_{eff}—effective focal length of the first camera in mm;

S—a CCD size within the first camera in mm; and

Ni—pixel size on the CCD of the biometric marker at distance Dᵢ.

As described above, the first image of the object and the first image of the biometric marker may be simultaneously acquired simultaneously and the second image of the object and the second image of the biometric marker may be acquired simultaneously.

The above-described method and apparatus provides for technique to measure a distant object by simultaneously using both a front camera 104 and back camera 105 of, for example, a cellular telephone. (In an alternate embodiment of the present invention a single camera may be used and/or the images acquired need not be taken simultaneously). The back camera is directed towards the object being measured, the front camera is directed to the operator of device 101. The measurement of the object is accomplished using two or more pictures of the object taken from different positions. A distance between these positions that is calculated from the pictures of one or several reference objects\points taken by the frontal camera.

Biometric markers are utilized for calculation of camera displacement (D). These sizes\distances are similar for most people, but they can be refined before measuring the height of an object. More particularly, a calibration process may be utilized that specifically tailors the biometric markers used to a specific individual. For example, a distance between a user's eyes may be physically measured and stored. This distance may then be used in calculating D.

Accuracy of measurements may be increased by increasing the number of pictures taken, and then averaging results. Moreover, two synchronized video flows, taken from the front and back cameras simultaneously, can be used for measuring object sizes by acquiring multiple images from the video flows.

As is evident, the measurements described above require the application of simple image processing technologies, any of which may be utilized. Technologies such as, but not limited to the Open Source Computer Vision Library OpenCV (www.opencv.org) can be used for detection of reference objects. For example, co-ordinates of operator's eyes can be obtained with the help of Cascade Classifier implemented in this library.

Detection of the target object in the pictures taken by the back camera and calculation of its pixel sizes is also accomplished with standard, off-the-shelf software such as above mentioned OpenCV image processing labrary Also, it is necessary to know a parameter being measured (height, width, length, . . . , etc.) for the distant object. While object height was described above, other measurements may be taken. For example, a sphere can be described using only one parameter—its radius, a box can be described using three parameters: height, width and depth, . . . , etc.

In the foregoing specification, specific embodiments have been described. However, one of ordinary skill in the art appreciates that various modifications and changes can be made without departing from the scope of the invention as set forth in the claims below. For example, although the above description was primarily given for a user determining a height of an object, any dimension of an object may be determined in a similar manner. Additionally, a distance to the object may also be determined in a similar manner.

Additionally, accuracy of the above described technique may be increased by calibrating the technique to a particular individual. For example, a distance between a person's eyes may vary slightly from individual to individual. A particular facial feature used in the calculations can be refined for a particular person using a calibration process. For example, a label having a known size can be used for these purposes. The label may be affixed do a person's head during the calibration procedure in order to more-accurately determine a size of facial features. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for calculating a size of an object, the method comprising the steps of:
acquiring a first image of the object;
acquiring a first image of a biometric marker at a first distance (D₁);
measuring a size (N₁) the biometric marker at the first distance;
acquiring a second image of the object;
acquiring a second image of the biometric marker at a second distance (D₂);
measuring a size (N₂) of the biometric marker at the second distance; and
calculating the size of the object (H) based on the size measurements of the biometric marker at the first and the second distances.

2. The method of claim 1 wherein the first and the second image of the object is acquired with a first camera, and the first and the second image of the biometric marker is acquired with a second camera.

3. The method of claim 1 wherein the biometric marker comprises a distance between the eyes or a size of a pupil.

4. The method of claim 1 wherein N₁ and N₂ are measured in pixel lengths.

5. The method of claim 1 further comprising the steps of:
determining a distance D as an absolute value of D₂−D₁; and
wherein
$$H = \frac{{H}_{1} \cdot {H}_{2} \cdot D}{\vert {H}_{1} - {H}_{2} \vert \cdot {F}_{pix}}$$
where,
Fₚᵢₓ is the focal length of a camera in pixels.

6. The method of claim 1 further comprising the steps of:
calculating D₁;
calculating D₂;
wherein
$${D}_{i} = \frac{L \cdot {F}_{pix}}{{N}_{i}} = \frac{L \cdot {F}_{eff} \cdot R}{{N}_{i} \cdot S}$$
where
L—is a size of the biometric marker in meters;
Fpix—focal length of a camera in pixels;
R—is the size of the biometric marker in meters;
F_{eff}—effective focal length of the camera in mm;
S—a CCD size within the camera in mm; and
Ni—pixel size on the CCD of the biometric marker at distance Dᵢ.

7. The method of claim 1 wherein the first image of the object and the first image of the biometric marker are acquired simultaneously and the second image of the object and the second image of the biometric marker are acquired simultaneously.

8. The method of claim 1 wherein the size of the object comprises a height, width, or length of the object.

9. An apparatus comprising:
a first camera acquiring a first image of the object and acquiring a second image of the object;
a second camera acquiring a first image of a biometric marker at a first distance (D₁) and acquiring a second image of the biometric marker at a second distance (D₂);
logic circuitry measuring a size (N₁) the biometric marker at the first distance, measuring a size (N₂) of the biometric marker at the second distance, and calculating the size of the object (H) based on the size measurements of the biometric marker at the first and the second distances.

10. The apparatus of claim 9 wherein the biometric marker comprises a distance between the eyes or a size of a pupil.

11. The apparatus of claim 9 wherein N₁ and N₂ are measured in pixel lengths.

12. The apparatus of claim 9 wherein the logic circuitry determines a distance D as an absolute value of D₂−D₁; and
wherein
$$H = \frac{{H}_{1} \cdot {H}_{2} \cdot D}{\vert {H}_{1} - {H}_{2} \vert \cdot {F}_{pix}}$$
where,
Fₚᵢₓ is the focal length of the first camera in pixels.

13. The apparatus of claim 9 wherein the logic circuitry calculates D₁ and D₂ as
$${D}_{i} = \frac{L \cdot {F}_{pix}}{{N}_{i}} = \frac{L \cdot {F}_{eff} \cdot R}{{N}_{i} \cdot S}$$
where
L—is a size of the biometric marker in meters;
Fpix—focal length of the first camera in pixels;
R—is the size of the biometric marker in meters;
F_{eff}—effective focal length of the first camera in mm;
S—a CCD size within the first camera in mm; and
Ni—pixel size on the CCD of the biometric marker at distance Dᵢ.

14. The apparatus of claim 9 wherein the first image of the object and the first image of the biometric marker are acquired simultaneously and the second image of the object and the second image of the biometric marker are acquired simultaneously.

15. The apparatus of claim 9 wherein the size of the object comprises a height, width, or length of the object.
